(19) United States
(12) Patent Application Publication
(10) Pub. No.: US 2010/0213327 A1
(43) Pub. Date: Aug. 26, 2010

(54) Ergonomically Designed Hand Rest

(76) Inventor: Patrice Ochs-Sobczak, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/540,662

(22) Filed: Aug. 13, 2009

Related U.S. Application Data
(60) Provisional application No. 61/096,914, filed on Sep. 15, 2008.

(51) Int. Cl. A41D 13/08; B23P 11/00

(52) U.S. Cl. 248/118; 29/428

(57) ABSTRACT

The present invention is an ergonomically designed apparatus and method for making an apparatus configured to provide hand, wrist, shoulder and/or neck support (and combinations thereof). In various embodiments, the apparatus may be made to be disposable or sanitary, and/or efficiently packaged, mass-produced and stored. The apparatus may be adapted for various anthropometric proportions and body types, and may be used in conjunction with various types of beds, examining tables, tables, chairs and other furniture. Various embodiments may be manufactured without seams and to minimize pressure points.

### CROSS-REFERENCE TO RELATED APPLICATIONS

This application claims priority to U.S. Provisional Application No. 61/096,914 filed on Sep. 15, 2008.

### FIELD OF INVENTION

The present invention relates to the field of hand rests and more particularly to the field of ergonomically designed hand rests.

### BRIEF DESCRIPTION OF THE DRAWINGS

FIG. 1a illustrates an exemplary embodiment of an ergonomically designed hand rest not in use.

FIG. 1b illustrates a second exemplary embodiment of an ergonomically designed hand rest not is use.

FIG. 2 illustrates an exemplary embodiment of an ergonomically designed hand rest in use by an individual in a slightly elevated position.

FIG. 3 illustrates an exemplary embodiment of an ergonomically designed hand rest in use by an individual in a seated position.

FIG. 4 illustrates an exemplary embodiment of an ergonomically designed hand rest in use in by an individual lying down.

### GLOSSARY

As used herein, the term “ergonomically designed” means a component which has been designed to minimize fatigue, discomfort and injuries.

As used herein, the term “torso spanning component” refers to a component that is used to span an individual's torso, abdomen, waist, and/or legs to relieve pressure from the wrists, hands, arm, shoulder, neck or other body areas. A torso spanning component may include, but is not limited to a strap, flap, panel or belt. A torso spanning component may partially span or completely encircle the waist or hip area, or any other area of the body within a user's arm span.

As used herein, the term “hand receptacle” refers to a component designed to accommodate the placement of one or both hands.

As used herein, the term “pressure points” refers to any point in which a hand support component or torso spanning component may come in contact with skin.

### BACKGROUND

Lying in a prone position without arm support may cause stress to the neck, shoulder, wrists, hands and other parts of the body. This is a particular problem when a patient or other individual is lying or sitting on a structure without arm support, such as an examination chair, a treatment chair, or a portable chair which may be used in emergency and/or disaster setting or in areas where treatment is required with limited access to beds and furnishings for patients.

For example, a problem known in the art is that standard medical examining tables have dimensions of approximately 27 inches by 70 inches. Standard examining tables do not have arms or rails leaving a patient without a comfortable place to rest his or her hands. When patients are lying on their back their hands must be placed at their sides, under their body, over their chest or behind or over their head. These are awkward positions that can create torque or pressure on the arms, shoulders, wrists or hands or cause one hands and/or arms to fall asleep. For larger individuals on the standard size examining tables, laying ones hands at his or her side may not even be an option.

Exam tables are available in a variety of widths (e.g., 28 inches, 34 inches, 40 inches); however, the larger width tables take up more space in the examining room leaving less space for other necessary equipment and giving doctors and nurses less space to maneuver.

Examining tables are available with adjustable features, such as controls for adjusting the height of all or a portion of the table or the length. Examining tables, however, do not allow for placement and removing of arms or sides. A few examining tables are available with safety grab bars (e.g., Brewer 6000 Access High-Low Exam Table manufactured by Brewer Company in Menomonee Falls, Wis.); however, the uses for these tables are limited as the grab bars make it more difficult to access the patient. In addition, the height of the grab bars is not adjustable and therefore may not be a comfortable for most patients to rest his or her arms and hands.

Individuals who are seated in chairs without armrests for extended periods of time (e.g., patients sitting in a waiting room) will often experience arm discomfort or pain resulting from sitting on their hands, or crossing their arms over their chest which causes stress on the shoulders, arms, wrists and hands.

In particular, individuals suffering from conditions such as arthritis of the hands, carpal tunnel syndrome, muscle weakness, tendon injuries, bruising, burns or other conditions may find resting their arms or hands on tables or chairs uncomfortable and often find it difficult to find a comfortable position in which to rest his or her arms and hands.

Individuals suffering from arthritis may use pillows or other makeshift devices to prop their hands up for relief, but pillows may facilitate dust and bacteria and are costly and require storage space, primarily because these devices provide support by providing “bulk” to take up space between a patient's hands and a bed.

There are examples of apparatuses designed to provide support to an individual's shoulders, arms and/or hands known in the prior art. One example is disclosed in U.S. Pat. No. 3,559,640 (Beckett '640). Beckett '640 discloses a piece of washable fabric material formed into a jacket-like garment which is roughly X-shaped. A pair of diverging wing panels can be shaped into forearm supporting pouches. Flaps are used to provide a snug fit for the elbow and upper arm. This device is costly to manufacture and is restrictive for a patient, as it requires use of a jacket-like structure to provide support.

Another example of a supportive apparatus is disclosed in U.S. Pat. No. 5,086,762 (Chee '762). Chee '762 discloses a typing brace apparatus which includes a rigid yoke having an upper pair of yoke arms. The use of a rigid yoke is costly to manufacture and uncomfortable and restrictive for a user.

U.S. Pat. No. 4,576,351 (Brink '351) discloses another example of a supportive apparatus. Brink '351 discloses a portable arm rest for a stroke victim which provides multi-positional means of comfort for an individual's arm by propping the arm at an incline to prevent accumulation of fluid in the hand and wrist area. The apparatus is designed to be secured to the arm of a chair or to a flat surface (e.g., a table). This apparatus is costly to manufacture and cannot be used with many types of beds or chairs. It is also not disposable or sanitary.

It is desirable to have an inexpensive, disposable and potentially sanitary device to provide hand, arm, wrist, neck and/or other support by allowing an individual to rest his or her arms/hands in a sitting or lying position.

It is further desirable to have a supportive device which is easily stored, packaged and inexpensive to manufacture.

It is further desirable to have an apparatus which is readily adaptable for an individual's body proportions and for a wide range of types of furniture and settings.

### SUMMARY OF THE INVENTION

The present invention is an ergonomically designed apparatus and method for making and apparatus configured to provide hand, wrist, shoulder and/or neck support (and combinations thereof). In various embodiments, the apparatus may be made disposable or sanitary, and efficiently packaged, mass-produced and stored. The apparatus may be adapted for various anthropometric proportions and body types, and may be used in conjunction with various types of beds, examining tables, tables, chairs and other furniture. Various embodiments may be manufactured without seams and to minimize pressure points, and may include hand support components of various shapes and configurations.

### DETAILED DESCRIPTION OF INVENTION

For the purpose of promoting an understanding of the present invention, references are made in the text to exemplary embodiments of an ergonomically designed hand rest, only some of which are described herein. It should be understood that no limitations on the scope of the invention are intended by describing these exemplary embodiments. One of ordinary skill in the art will readily appreciate that alternate but functionally equivalent materials, dimensions and configurations may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

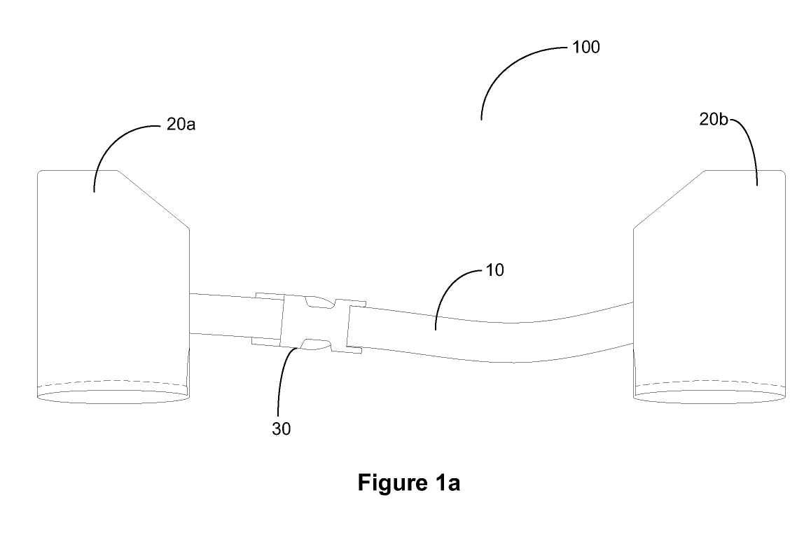

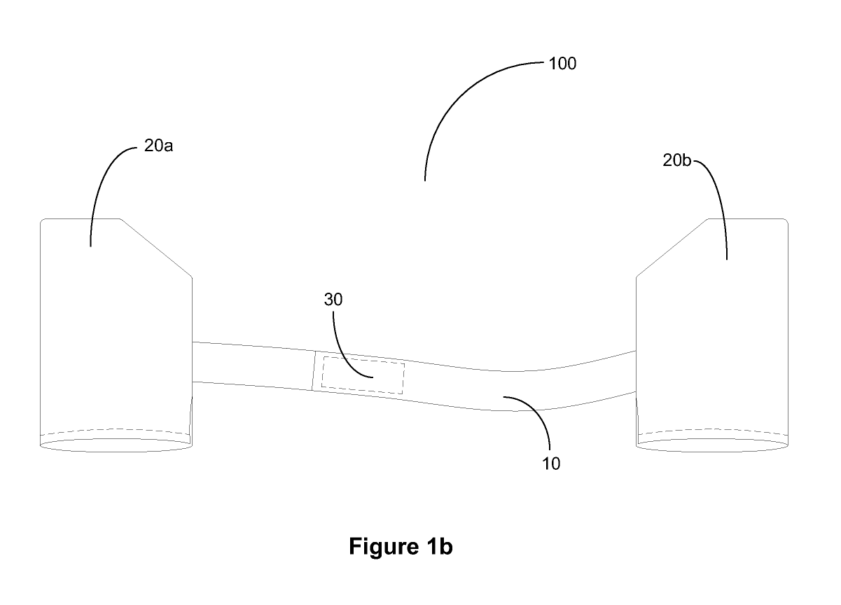

FIG. 1a illustrates an exemplary embodiment of ergonomically designed hand rest 100 not in use. Ergonomically designed hand rest 100 has torso spanning component 10 and hand receptacles 20a, 20b. In the embodiment shown, torso spanning component 10 is a flat nylon strap. In other embodiments, torso spanning component 10 is an elastic strap, a polypropylene strap, a belt, a flap, cable, a rigid structure or any other component capable of connecting hand receptacles 20a, 20b. In other embodiments, torso spanning component 10 may be padded for increased comfort.

In the embodiment shown, hand receptacles 20a, 20b consist of two panels of a breathable mesh fabric which facilitates airflow. Hand receptacles 20a, 20b may be constructed without seams and with features to avoid or minimize pressure points. In other embodiments, hand receptacles 20a, 20b have more or fewer panels and/or are made of a cotton fabric, fleece, a disposable material or any other material that is soft against the skin. In the embodiment shown, hand receptacles 20a, 20b are sized to loosely accommodate any size hand with additional space to move around.

In the embodiment shown, torso spanning component 10 further includes optional adjusting mechanism 30. In the embodiment shown, adjustment mechanism 30 is a side release buckle which also allows for adjustment of the length of torso spanning component 10 in order to accommodate various sizes of individuals. In other embodiments, adjustment mechanism 30 is a plurality of hook and loop fasteners, a loop configuration, a series of snaps, adjustable fasteners and combinations thereof.

FIG. 1b illustrates a second exemplary embodiment of ergonomically designed hand rest 100 not in use which includes ventilation holes 33 for air flow. Ergonomically designed hand rest 100 has torso spanning component 10 and hand receptacles 20a, 20b. In the embodiment shown, torso spanning component 10 is a flat nylon strap. In other embodiments, torso spanning component 10 is an elastic strap, a polypropylene strap, a rope, a rigid structure or any other component capable of connecting hand receptacles 20a, 20b. In other embodiments, torso spanning component 10 may be padded for increased comfort.

In the embodiment shown, hand receptacles 20a, 20b consist of two panels of a breathable mesh fabric. In other embodiments, hand receptacles 20a, 20b have more or fewer panels and/or are made of a cotton fabric, fleece, a disposable material or any other material that is soft against the skin. In the embodiment shown, hand receptacles 20a, 20b are wider on one side to accommodate thumb movement. In still other embodiments, hand receptacles 20a, 20b may be glove shaped, mitt shaped, have thumb or finger holes, square, elongated, padded, rounded or irregularly shaped. In still other embodiments, hand receptacles 20a, 20b may include apertures for intravenous devices, or receptacles for other devices such as heating pads, ice packs or electronic signaling or sensing devices. In various embodiments hand receptacles 20a, 20b may be adapted to be easily folded and stored or packaged in a small receptacle. In still other embodiments, hand receptacles 20a, 20b may be stretchable or come in various sizes. In still other embodiments, hand receptacles 20a, 20b may be adapted to fit snugly against the hands to provide support.

In the embodiment shown, torso spanning component 10 further includes optional adjusting mechanism 30 and optional padding 37. In the embodiment shown, adjustment mechanism 30 is a plurality of hook and loop fasteners which allow for adjustment of the length of torso spanning component 10 in order to accommodate various sizes of individuals. In other embodiments, adjustment mechanism 30 is a buckle, a loop configuration, a series of snaps, adjustable fasteners and combinations thereof.

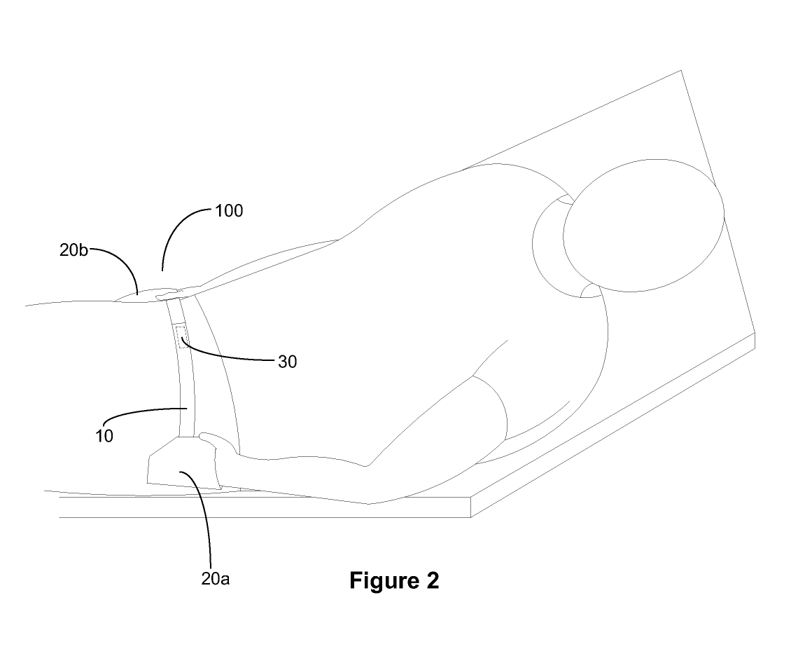

FIG. 2 illustrates an exemplary embodiment of ergonomically designed hand rest 100 in use by an individual in a slightly elevated position (e.g., on a therapy table or in a hospital bed). Ergonomically designed hand rest 100 has torso spanning component 10 and hand receptacles 20a, 20b. Torso spanning component 10 lays across the individual's lap and the individual's hands are inserted into hand receptacles 20a, 20b. When the length of torso spanning component 10 is adjusted or sized to fit a particular individual, torso spanning component 10 suspends the individual's hands weightlessly on the individual's side providing stability and allowing the are individual's arms and shoulders to lay in a rested, comfortable position.

In the embodiment shown, torso spanning component 10 is a flat nylon strap. In other embodiments, torso spanning component 10 is an elastic strap, a polypropylene strap, a rope, a rigid structure or any other component capable of connecting hand receptacles 20a, 20b. In other embodiments, torso spanning component 10 may be padded for increased comfort.

In the embodiment shown, hand receptacles 20a, 20b consist of two panels of a breathable mesh fabric. In other embodiments, hand receptacles 20a, 20b have more or fewer panels and/or are made of a cotton fabric, fleece, a disposable material or any other material that is soft against the skin. In other embodiments, hand receptacles 20a, 20b are washable or disposable.

In the embodiment shown, torso spanning component 10 further includes optional adjusting mechanism 30. In the embodiment shown, adjustment mechanism 30 is plurality of hook and loop fasteners which allow for adjustment of the length of torso spanning component 10 in order to accommodate various sizes of individuals. In other embodiments, adjustment mechanism 30 is a buckle, a loop configuration, a series of snaps, adjustable fasteners and combinations thereof.

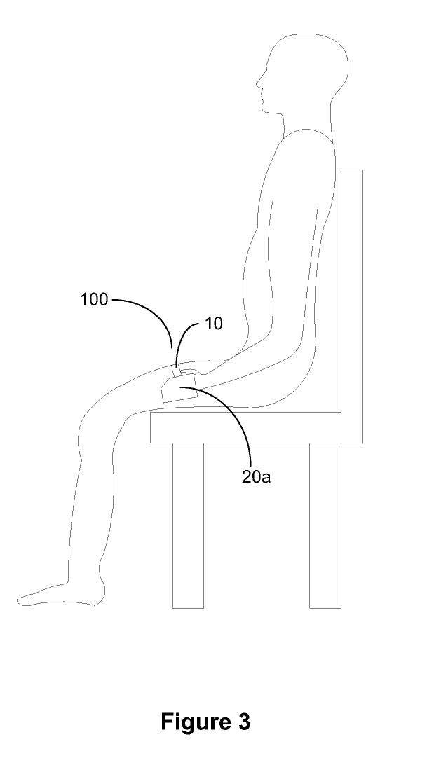

FIG. 3 illustrates an exemplary embodiment of ergonomically designed hand rest 100 in use by an individual in a seated position. Visible are torso spanning component 10 and hand receptacle 20a. Not visible are hand receptacle 20b and adjustment mechanism 30.

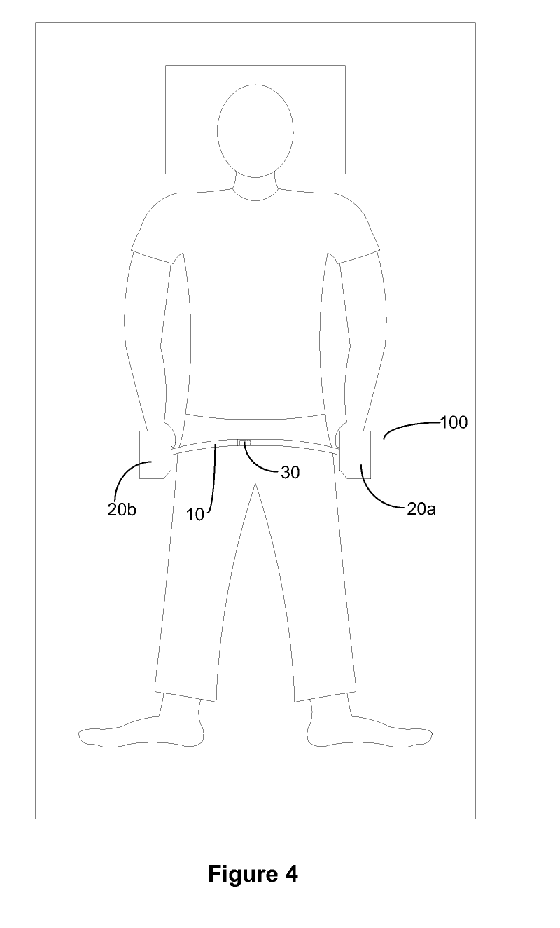

FIG. 4 illustrates an exemplary embodiment of ergonomically designed hand rest 100 in use in by an individual lying down. Visible are torso spanning component 10, hand receptacles 20a, 20b and adjustment mechanism 30. In the embodiment shown, adjustment mechanism 30 is a plurality of hook and loop fasteners.

What is claimed is:

1. An ergonomically designed hand support apparatus comprised of:
a torso spanning component having a first end and a second end;
a first hand receptacle fixedly attached to said first end of said torso spanning component; and
a second hand receptacle fixedly attached to said second end of said torso spanning component.

2. The ergonomically designed hand support apparatus of claim 1 wherein said torso spanning component is adjustable.

3. The ergonomically designed hand support apparatus of claim 1 wherein said torso spanning component may be adjusted using a device selected from the group consisting of a sliding buckle, hook and loop fasteners, a loop configuration, a series of snaps, adjustable fasteners and combinations thereof.

4. The ergonomically designed hand support apparatus of claim 1 wherein said torso spanning component is positioned to support the wrists.

5. The ergonomically designed hand support apparatus of claim 1 wherein said first hand receptacle and said second hand receptacle are wider at one side to accommodate movement of the thumbs.

6. The ergonomically designed hand support apparatus of claim 1 wherein said first hand receptacle and said second hand receptacle are comprised of two panels which are constructed of a disposable material.

7. The ergonomically designed hand support apparatus of claim 1 wherein said first hand receptacle and said second hand receptacle include at a least one hole for ventilation.

8. The ergonomically designed hand support apparatus of claim 1 wherein said first hand receptacle and said second hand receptacle are detachable from said torso spanning component.

9. The ergonomically designed hand support apparatus of claim 1 wherein said first hand receptacle and said second hand receptacle are constructed of mesh.

10. The ergonomically designed hand support apparatus of claim 1 wherein said first hand receptacle and said second hand receptacle are seamless.

11. The ergonomically designed hand support apparatus of claim 1 wherein said torso spanning component is a rigid structure which supports the hands without applying pressure to the torso.

12. The ergonomically designed hand support apparatus of claim 1 wherein said torso spanning component further includes padding.

13. The ergonomically designed hand support apparatus of claim 1 which is adapted to be packaged in a substantially sterile manner.

14. A method of making an ergonomically designed hand support apparatus comprised of the steps of:
making a torso spanning component having a first end and a second end;
creating a first hand receptacle and a second hand receptacle;
fixedly attaching said first end of said torso spanning component to said first hand receptacle; and
fixedly attaching said second end of said torso spanning component to said second hand receptacle.

15. The method of making an ergonomically designed hand support apparatus which further includes the step of adjusting said torso spanning component to accommodate the body proportions of a user.

16. The method making an ergonomically designed hand support apparatus of claim 14 wherein said first hand receptacle and said second hand receptacle are seamless and constructed to minimize pressure points.

17. The method making an ergonomically designed hand support apparatus of claim 14 wherein said first hand receptacle and said second hand receptacle are constructed of mesh.

18. The method making an ergonomically designed hand support apparatus of claim 14 wherein said torso spanning component is a flexible strap.

19. The method making an ergonomically designed hand support apparatus of claim 14 wherein said torso spanning component is a rigid structure which supports the hands without applying pressure to the torso.
